(19) United States
(12) Patent Application Publication
(10) Pub. No.: US 2008/0147218 A1
(43) Pub. Date: Jun. 19, 2008

(54) Recording/reproduction apparatus

(76) Inventors: Yukari SUGINO, Osaka (JP); Ichiro KAWASHIMA, Osaka (JP); Yoshiaki SAWADA, Osaka (JP); Hiroyuki GOTO, Osaka (JP); Seigo SUGUTA, Osaka (JP)

Correspondence Address: MCDERMOTT WILL & EMERY LLP, 600 13TH STREET, NW, WASHINGTON, DC, 20005-3096, US

(21) Appl. No.: 11/979,402

(22) Filed: Nov. 2, 2007

(30) Foreign Application Priority Data
Dec. 15, 2006 (JP) 2006-338282

(51) Int. Cl. G06F 17/00

(52) U.S. Cl. 700/94

(57) ABSTRACT

A song change detecting section and a frame boundary division section are provided. The song change detecting section reads, for example, a subcode corresponding to audio data read by a control section as song location information, and based on a song number included in the subcode, determines whether the audio data is located midway through a song or at a boundary between songs, and notifies the result. The frame boundary division section performs no process when a notification from the song change detecting section indicates that the audio data is located midway through a song, and writes dummy data into an encoded data buffer so that encoded data can be divided at a frame boundary and notifies the outside of a division location when the audio data is located at a boundary between songs. Thereby, in a recording/reproduction apparatus which performs reproduction and recording simultaneously, even when audio data including different song numbers is continuously input, encoded data can be divided into song numbers and recorded without interruption of reproduction.

### BACKGROUND OF THE INVENTION

1. Field of the Invention

The present invention relates to a recording/reproduction apparatus for reproducing audio data, and at the same time, compression-encoding and recording the audio data.

2. Description of the Related Art

In recent years, there are well-known recording/reproduction apparatuses for reading and reproducing audio data recorded on CDs (Compact Discs) or the like, and at the same time, saving encoded data which is obtained by compression encoding using an algorithm, such as MP3 (MPEG-1 Audio Layer-3), AAC (Advanced Audio Coding) or the like, into a semiconductor memory or a hard disk.

According to a certain conventional technique, a plurality of songs having different song numbers in a live CD on which no silent time is present between each song are continuously compression-encoded and recorded into a single music file, while information about the starting locations of the songs is recorded into another file. When a song number is specified and reproduced, reproduction is started from the specified song in the music file with reference to the location information file (see Japanese Unexamined Patent Application Publication No. 2004-93729).

However, there is still a users' strong demand for dividing encoded data into song numbers, which are in turn recorded.

According to the MP3 format, audio data is encoded in units of a frame which includes a predetermined number of samples, into MP3 data composed of a header and main data. Due to the structure of MP3, the main data of a frame may be mixed into the previous frame. Therefore, for example, if song numbers are changed at a boundary between frames of audio data, then when these frames are successively encoded, data of the succeeding frame is mixed into data of the preceding frame, so that MP3 data may not be divided into song numbers. To solve this problem, it may be contemplated that the leading frame of a song immediately after changing is encoded twice. However, when songs are changed, the processing load temporarily increases, likely leading to underflow of an output buffer for reproduction, which interrupts reproduction.

### SUMMARY OF THE INVENTION

In view of the above-described problems, the present invention has been achieved. An object of the present invention is to provide a recording/reproduction apparatus for performing recording and reproduction simultaneously, in which, even when audio data including different song numbers is continuously input, encoded data is divided into song numbers and recorded without interruption of reproduction.

To achieve the object, a recording/reproduction according to the present invention comprises a control section for reading audio data in units of a predetermined number of samples and outputting the audio data, a buffer for temporarily storing audio data from the control section, a decoder section for performing a decoding process so as to reproduce audio data in the buffer, an output buffer for temporarily storing decoded data from the decoder section and outputting the decoded data at a predetermined rate, an encoder section for performing an encoding process so as to record audio data in the buffer, an encoded data buffer for temporarily storing encoded data from the encoder section and outputting the encoded data, a song change detecting section for reading song location information corresponding to audio data read by the control section, determining whether the audio data is located midway through a song or at a boundary between songs based on the song location information, and notifying the result, and a frame boundary division section for performing no process when a notification from the song change detecting section indicates that the audio data is located midway through a song, and performing a process of dividing encoded data in the encoded data buffer when the notification indicates that the audio data is located at a boundary between songs, and notifying the outside of a division location of the encoded data.

According to the present invention, even when audio data including different song numbers is continuously input, encoded data can be divided into song numbers and recorded. In addition, the process of dividing encoded data at frame boundaries can be executed relatively quickly. Therefore, it is possible to prevent underflow of an output buffer for reproduction due to a temporary increase in processing load when songs are changed.

### BRIEF DESCRIPTION OF THE DRAWINGS

FIG. 1 is a block diagram showing an exemplary configuration of a recording/reproduction apparatus according to the present invention.

FIG. 2 is a diagram showing exemplary structures of audio data and MP3 data in the recording/reproduction apparatus of FIG. 1.

FIG. 3 is a diagram showing another exemplary structure of audio data and MP3 data in the recording/reproduction apparatus of FIG. 1.

### DETAILED DESCRIPTION OF THE PREFERRED EMBODIMENTS

Hereinafter, embodiments of the present invention will be described with reference to the accompanying drawings.

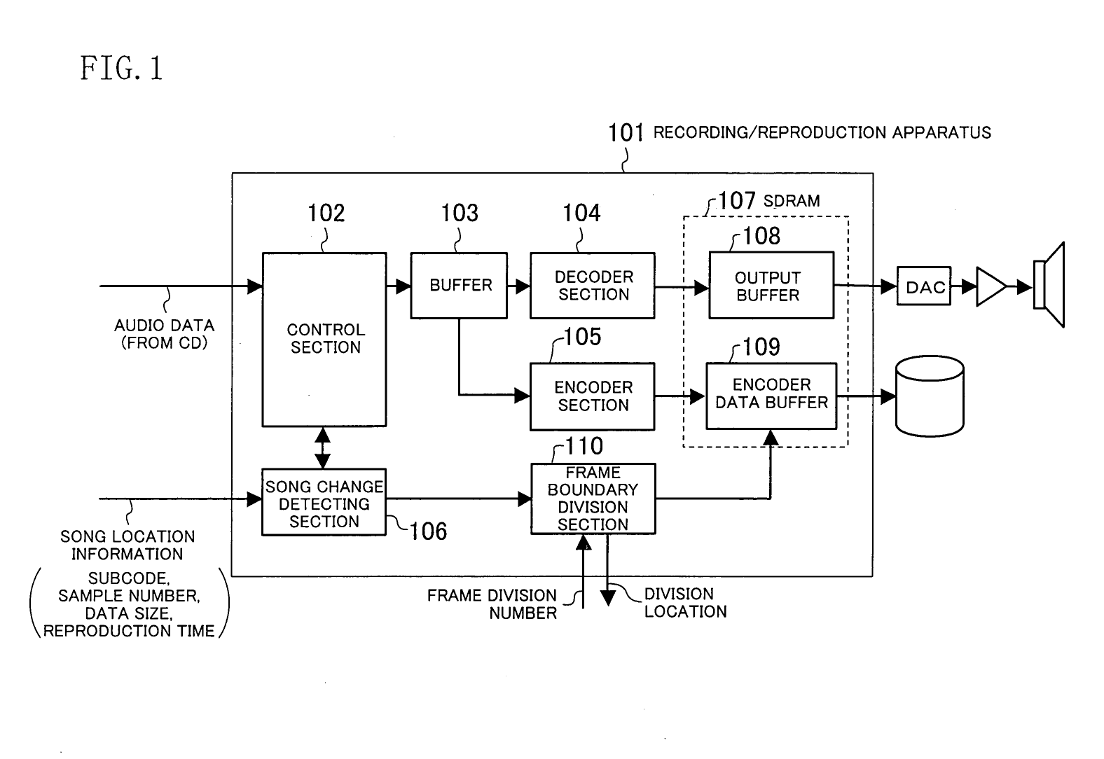

FIG. 1 shows an exemplary configuration of a recording/reproduction apparatus according to the present invention. The recording/reproduction apparatus 101 of FIG. 1 reproduces audio data from, for example, a CD, and at the same time, records compression-encoded data. The recording/reproduction apparatus 101 comprises a control section 102 for reading and outputting audio data in units of a frame (e.g., 1152 samples), a buffer 103 for temporarily storing audio data from the control section 102, a decoder section 104 for reading a frame of data from the buffer 103 and subjecting the data to a decoding process for reproduction, an output buffer 108 for temporarily storing decoded data from the decoder section 104 and outputting the data at a predetermined rate, an encoder section 105 for reading a frame of data from the buffer 103 and subjecting the data to an encoding process for recording, and an encoded data buffer 109 for temporarily storing encoded data from the encoder section 105 and outputting the data to a semiconductor memory or a hard disk, and in addition, a song change detecting section 106 and a frame boundary division section 110. Each of the parts performs a process in a time-division manner. Data which is subjected to the decoding process in the decoder section 104 and data which is subjected to the encoding process in the encoder section 105 are the same data in the buffer 103. The output buffer 108 and the encoded data buffer 109 are provided in an SRAM 107.

On CDs, a subcode including a song number or the like is recorded every a predetermined number of samples (e.g., 588 samples) in audio data. The song change detecting section 106 can utilize the subcode as a kind of song location information. The number of samples, the data size, the reproduction time of a song or the like of audio data can be used as song location information.

The song change detecting section 106 reads song location information corresponding to audio data read by the control section 102, and based on the song location information, determines whether the audio data is located midway through a song or at a boundary between songs, and notifies the frame boundary division section 110 of the result.

When the notification from the song change detecting section 106 indicates that the audio data is located midway through a song, the frame boundary division section 110 performs no process. When the notification from the song change detecting section 106 indicates that the audio data is located at a boundary between songs, the frame boundary division section 110 writes dummy data into the encoded data buffer 109 so as to divide encoded data at a frame boundary, and notifies the outside of the division location.

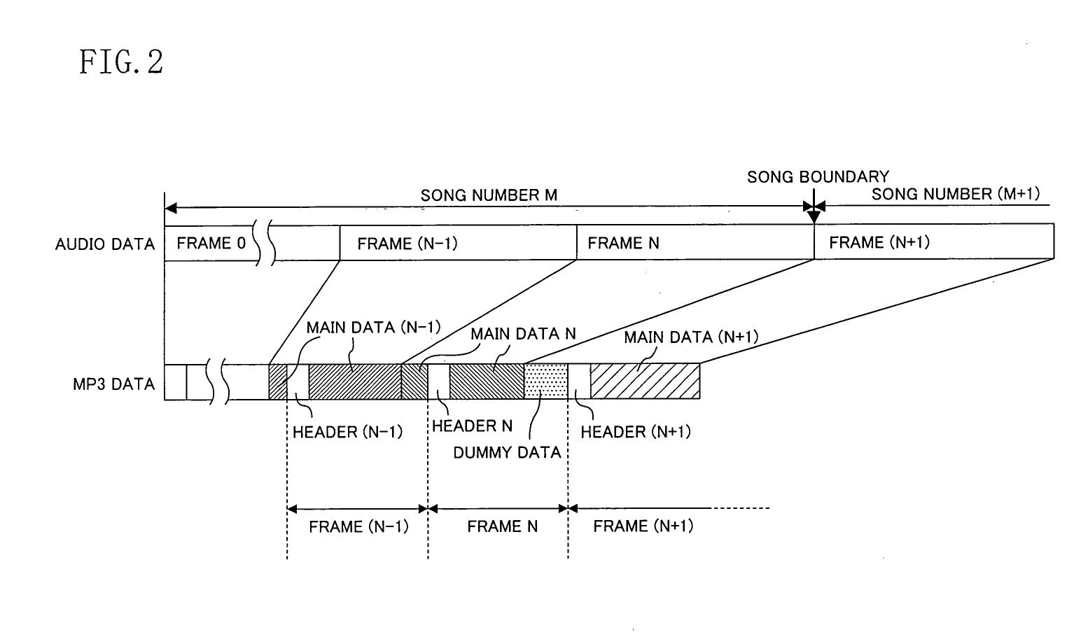

FIG. 2 shows exemplary structures of audio data and MP3 data in the recording/reproduction apparatus 101 of FIG. 1. In the encoder section 105 of FIG. 1, it is assumed that either MP3 or AAC can be selected, and it is now assumed that MP3 is selected. It is also assumed that a song number M is changed to a song number M+1 at a boundary between a frame N and a frame (N+1) of audio data, where M and N are natural numbers.

According to the MP3 format, as described above, audio data is encoded in units of a frame which includes a predetermined number of samples, into MP3 data composed of a header and main data. As shown in FIG. 2, a frame (N−1) is encoded to generate a header (N−1) and main data (N−1), and a frame N is encoded to generate a header N and main data N, and a frame (N+1) is encoded to generate a header (N+1) and main data (N+1). A frame of MP3 data spans from the head end of a header to the head end of the next header. The data size of a frame is determined based on a bit rate of MP3 data.

A process in the song change detecting section 106 will be described in detail with reference to FIG. 2. It is here assumed that a subcode corresponding to audio data read by the control section 102 is read as song location information by the song change detecting section 106, which in turn determines whether the audio data is located midway through a song or at a boundary between songs based on a song number included in the subcode.

Initially, when a frame 0 of audio data is read by the control section 102, the song change detecting section 106 reads a subcode corresponding to the frame 0 of audio data. The frame 0 of audio data is data which is first input after activation of the recording/reproduction apparatus 101, so that a song number M of the frame 0 is set as an initial song number. Thereafter, every time the control section 102 reads each of frames 1 to N of audio data, the song change detecting section 106 reads a subcode corresponding to the audio data to determine a song number. Since the song numbers of the frames 0 to N of audio data are M, the song change detecting section 106 determines that the frames 0 to N are located midway through a song.

When the control section 102 reads a frame (N+1) of audio data, the song change detecting section 106 reads a subcode corresponding to the frame (N+1) of audio data. Since the frame (N+1) of audio data has a song number M+1, the song change detecting section 106 determines that the frame (N+1) is located at a boundary between songs.

Next, a process in the frame boundary division section 110 will be described in detail with reference to FIG. 2. During the frames 0 to N of audio data, a notification from the song change detecting section 106 indicates that the frames 0 to N are located midway through a song, so that the frame boundary division section 110 performs no process. Therefore, data encoded by the encoder section 105 is stored, without modification, into the encoded data buffer 109. At the frame (N+1) of audio data, a notification from the song change detecting section 106 indicates that the frame (N+1) is located at a boundary between songs. In this case, the frame boundary division section 110 inserts dummy data between the tail end of the main data N and the head end of the header (N+1), so that no portion of the main data (N+1) is caused to mix into the frame N. Here, the tail end of the main data N is the tail end of the song number M, and the head end of the header (N+1) is the head end of the song number (M+1). Thereafter, when the frame (N+1) of audio data is encoded by the encoder section 105, the main data (N+1) is located from the tail end of the header (N+1), so that encoded data can be divided at the head end of the header (N+1). The frame boundary division section 110 notifies the outside of an address of the head end of the header (N+1) in the encoded data buffer 109 as a division location of encoded data.

As described above, according to the recording/reproduction apparatus 101 of FIG. 1, even when audio data including different song numbers is continuously input, encoded data can be divided into song numbers and recorded without interruption of reproduction.

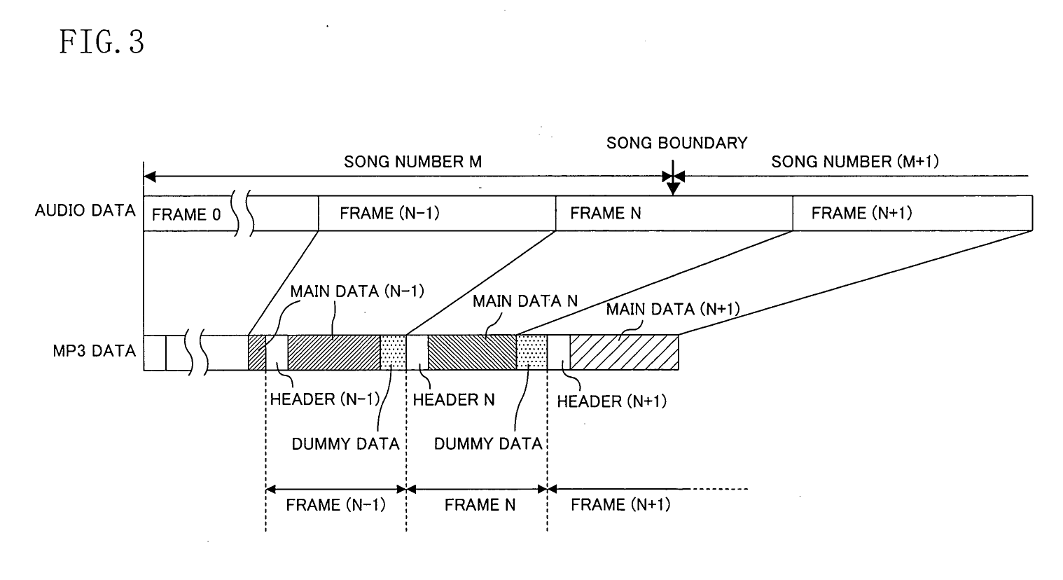

FIG. 3 shows an example in which song numbers are changed midway through a frame of audio data in the recording/reproduction apparatus 101 of FIG. 1. An example in which, during a plurality of frames including a frame having a boundary between songs, the frame boundary division section 110 is continuously operated so that encoded data in the encoded data buffer 109 can be divided at frame boundaries, will be described in detail with reference to FIG. 3.

When a song number M is changed to a song number M+1 midway through a frame N of audio data as shown in FIG. 3, the song change detecting section 106 determines that frames 0 to (N−1) of audio data are located midway through a song since the frames 0 to (N−1) have the song number M. Next, when the control section 102 reads the frame N of audio data, the song change detecting section 106 detects the song number (M+1) and determines that the frame N is located at a boundary between songs. On the other hand, during the frames 0 to (N−1) of audio data, a notification from the song change detecting section 106 indicates that the frames 0 to (N−1) are located midway through a song, so that the frame boundary division section 110 performs no process. Therefore, data encoded by the encoder section 105 is stored, without modification, into the encoded data buffer 109. At the frame N of audio data, a notification from the song change detecting section 106 indicates that the frame N is located at a boundary between songs, so that the frame boundary division section 110 inserts dummy data between the tail end of the main data (N−1) and the head end of the header N, whereby no portion of the main data N is caused to mix into the frame (N−1). Thereafter, when the frame N of audio data is encoded by the encoder section 105, the main data N is located from the tail end of the header N, so that encoded data can be divided at the head end of the header N. Further, in the case of the next frame (N+1) of audio data, similarly, the frame boundary division section 110 inserts dummy data between the tail end of the main data N and the head end of the header (N+1), whereby no portion of the main data (N+1) is caused to mix into the frame N. Therefore, encoded data can also be divided at the head end of the header (N+1). If this process is repeatedly performed during several frames, a plurality of locations can be generated where encoded data can be divided.

It is apparent from the data structure of FIG. 3 that, if a boundary between songs in audio data is located midway through the frame N, then when encoded data is divided at the header N, data in a tail portion of the song number M is included in a head portion of the song number (M+1). Also, when the encoded data is divided at the header (N+1), data in a head portion of the song number (M+1) is included in a tail portion of the song number M. Also, when the encoder section 105 itself has delayed data, data in a tail portion of the song number M may be included in the frame (N+1) and later. In such a case, if encoded data is arranged to be able to be divided at frame boundaries during several frames after a song boundary, a division location for the encoded data can be selected, depending on a song boundary location.

As shown in FIG. 1, for the frame boundary division section 110, the number of frames in which encoded data in the encoded data buffer 109 can be divided at frame boundaries may be preferably externally specified as a frame division number.

The song change detecting section 106 may utilize the number of samples, the data size, the reproduction time of a song or the like of audio data as song location information, monitor audio data read by the control section 102, and determine whether the audio data is located midway through a song or at a boundary between songs based on the song location information. For example, when the number of samples is used as song location information, the song change detecting section 106 monitors the number of samples in audio data read by the control section 102, and notifies that the audio data is located midway through a song when the number of samples in the read audio data is not equal to the number of samples in the externally specified song location information, and notifies that the audio data is located at a boundary between songs when the two sample numbers are equal to each other.

Although it has been assumed above that the compression-encoding format of the encoder section 105 is MP3, the present invention is also applicable to an arrangement in which encoded data is extended over a plurality of frames, e.g., AAC SBR (Spectral Band Replication), and a similar effect is obtained.

As described above, the recording/reproduction apparatus of the present invention is effective when encoded data is divided into song numbers and recorded simultaneously with reproduction while audio data including different song numbers is input.

What is claimed is:

1. A recording/reproduction apparatus comprising:
a control section for reading audio data in units of a predetermined number of samples and outputting the audio data;
a buffer for temporarily storing audio data from the control section;
a decoder section for performing a decoding process so as to reproduce audio data in the buffer;
an output buffer for temporarily storing decoded data from the decoder section and outputting the decoded data at a predetermined rate;
an encoder section for performing an encoding process so as to record audio data in the buffer;
an encoded data buffer for temporarily storing encoded data from the encoder section and outputting the encoded data;
a song change detecting section for reading song location information corresponding to audio data read by the control section, determining whether the audio data is located midway through a song or at a boundary between songs based on the song location information, and notifying the result; and
a frame boundary division section for performing no process when a notification from the song change detecting section indicates that the audio data is located midway through a song, and performing a process of dividing encoded data in the encoded data buffer when the notification indicates that the audio data is located at a boundary between songs, and notifying the outside of a division location of the encoded data.

2. The recording/reproduction apparatus of claim 1, wherein
data which is subjected to the decoding process in the decoder section and data which is subjected to the encoding process in the encoder section are the same data in the buffer.

3. The recording/reproduction apparatus of claim 2, wherein
if the notification from the song change detecting section indicates that the audio data is located at a boundary between songs, the frame boundary division section writes dummy data between the tail end of the encoded data in the encoded data buffer and the head end of the first frame in the next song.

4. The recording/reproduction apparatus of claim 2, wherein
the frame boundary division section can divide the encoded data in the encoded data buffer at frame boundaries during a plurality of frames including a frame having a boundary between songs.

5. The recording/reproduction apparatus of claim 4, wherein
for the frame boundary division section, the number of frames into which the encoded data in the encoded data buffer can be divided at frame boundaries is externally specified as a frame division number.

6. The recording/reproduction apparatus of claim 2, wherein
the song change detecting section reads, as the song location information, a subcode corresponding to audio data read by the control section, and based on a song number included in the subcode, determines whether the audio data is located midway through a song or at a boundary between songs.

7. The recording/reproduction apparatus of claim 2, wherein
the song change detecting section determines the audio data is located midway through a song or at a boundary between songs based on the song location information whole monitoring audio data read by the control section.
